(19) United States
(12) Patent Application Publication
(10) Pub. No.: US 2011/0123829 A1
(43) Pub. Date: May 26, 2011

(54) Composite coating for finishing of hardened steels

(75) Inventors: Jacob Sjolen, Fagersta (SE); Tommy Larsson, Angelsberg (SE); Lennart Karlsson, Fagersta (SE)

(73) Assignee: SECO TOOLS AB, Fagersta (SE)

(21) Appl. No.: 12/931,211

(22) Filed: Jan. 27, 2011

Related U.S. Application Data
(62) Division of application No. 11/455,842, filed on Jun. 20, 2006.

(30) Foreign Application Priority Data
Jun. 22, 2005 (SE) 0501487-3

(51) Int. Cl. B32B 9/00; B01J 19/08

(52) U.S. Cl. 428/698; 427/535

(57) ABSTRACT

The present invention relates to a cutting tool insert, solid end mill, or drill, comprising a substrate and a coating. The coating is composed of one or more layers of refractory compounds of which at least one layer comprises a cubic (Me,Si)X phase, where Me is one or more of the elements Ti, V, Cr, Zr, Nb, Mo, Hf, Ta and Al, and X is one or more of the elements N, C, O or B. The ratio R=(at-% X)/(at-% Me) of the c-MeSiX phase is between 0.5 and 1.0 and X contains less than 30 at-% of O+B. This invention is particularly useful in metal machining applications where the chip thickness is small and the work material is hard e.g. copy milling using solid end mills, insert milling cutters or drilling of hardened steels.

### BACKGROUND OF THE INVENTION

The present invention relates to a cutting tool for machining by chip removal consisting of a substrate of cubic boron nitride based material and a hard and wear resistant refractory coating of which at least one layer comprises an Me—Si—X phase formed during the deposition either as a single phase or by co-deposition together with other phases or the same phase with different chemical composition. The tool according to the invention is particularly useful in metal cutting applications where the chip thickness is small and the work material is hard, e.g. finishing of hardened steels.

Cubic boron nitride, cBN, has a hardness and thermal conductivity next to diamond and excellent characteristics such that reactivity with ferrous metals is lower than diamond. Cutting tools using a polycrystalline cubic boron nitride, PcBN, such as sintered bodies containing cBN are used instead of tools of cemented carbides or cermets when machining hardened steel, cast iron and nickel based alloys in order to improve the working efficiency.

PcBN sintered bodies for cutting tools comprise cBN particles and a binder. They are generally classified into the following two groups:
Sintered bodies well-balanced in wear resistance as well as strength mainly used for hardened steels, comprising 30 to 80 volume % of cBN particles bonded through a binder predominantly consisting of Ti type ceramics such as TiN, TiC, Ti(C,N), etc.
Sintered bodies excellent in thermal conductivity as well as strength mainly used for cast irons comprising 80 to 90 volume % of cBN particles directly bonded and the balance of a binder generally consisting of an Al compound or Co compound.

However, cBN particles have the disadvantages that their affinity for ferrous metals is larger than TiN, TiC, Ti(C,N) binders. Accordingly, cutting tools employing cBN often have a shortened service life due to thermal abrasion, which eventually causes the tool edge to break. In order to further improve the wear resistance and fracture strength of a PcBN tool, it has been proposed to coat a PcBN tool with a layer of TiN, Ti(C,N), (Ti,Al)N, etc, e.g. U.S. Pat. No. 5,853,873 and U.S. Pat. No. 6,737,178.

However, a coated PcBN tool meets with a problem that an unexpected delamination of the layer often occurs.

JP-A-1-96083 and JP-A-1-96084 disclose improving the adhesive strength of a PcBN tool coated with a layer consisting of nitride, carbide or carbonitride of titanium through a metallic Ti-layer with an average thickness of 0.05-0.3 p.m.

U.S. Pat. No. 5,853,873 discloses a TiN layer as an intermediate layer between a cBN substrate and (Ti,Al)N-coated film to bond the (Ti,Al)N-coated film thereto with a high adhesive strength.

U.S. Pat. No. 6,737,178 discloses layers of TiN, Ti(C,N), (Ti,Al)N, Al₂O₃, ZrN, ZrC, CrN, VN, HfN, HfC and Hf(C,N).

U.S. Pat. No. 6,620,491 discloses a surface-coated boron nitride tool, with a hard coated layer and an intermediate layer consisting of at least one element selected from the Groups 4a, 5a and 6a of Periodic Table and having a thickness of at most 1 μm. The hard coating contains at least one layer containing at least one element selected from the group consisting of Group 4a, 5a, 6a elements, Al, B, Si and Y and at least one element selected from the Group consisting of C, N and O with a thickness of 0.5-10 μm. The intermediate layer contains at least one of the elements Cr, Zr and V.

U.S. Pat. No. 6,811,580, U.S. Pat. No. 6,382,951 and U.S. Pat. No. 6,382,951 disclose cubic boron nitride inserts coated with Al₂O₃.

### SUMMARY OF THE INVENTION

It is an object of the present invention to provide an improved cutting tool based on a sintered body comprising a high-pressure phase type boron nitride such as cBN having a coating excellent in adhesive strength aimed for machining by chip removal of hardened steel or cast iron.

It is a further object of the present invention to provide a method for depositing a coating on a cutting tool based on PcBN excellent in adhesive strength aimed for machining by chip removal of hardened steel or cast iron.

It has been found that the tribological properties of the coated tool can be significantly improved by applying a coating with optimised properties and processing onto a PcBN based cutting tool. By balancing the chemical composition, the amount of thermal energy and the degree of ion induced surface activation during growth, layers containing an (Me,Si)X phase can be obtained which, compared to prior art, display enhanced performance in metal cutting of hardened steel. The adhesion of the layer is superior due to optimised pre-treatment and deposition conditions. The layer(s) comprises grains of (Me,Si)X with or without the co-existence of grains of other phases. The layer(s) are deposited using PVD-techniques, preferably arc evaporation.

### BRIEF DESCRIPTION OF THE DRAWINGS

FIG. 1: CuKα X-ray diffraction pattern in θ-2θ geometry obtained from an as-deposited Ti_{0.77}Si_{0.23}N-layer on a PcBN substrate according to the invention. The indices in the figure refer to the NaCl-type structure of the coating i.e. (Ti,Si)N.

FIG. 2: CuKα X-ray diffraction pattern using a constant gracing incident angle of 1° between primary beam and sample surface from an as-deposited Ti_{0.77}Si_{0.23}N-layer on a PcBN substrate according to the invention. The indices in the figure refer to the NaCl-type structure of the coating i.e. (Ti,Si)N.

FIG. 3: SEM micrograph showing the structure of a PcBN material after conventional ion etching prior to coating.

FIG. 4: SEM micrograph showing the structure of a PcBN material after ion etching according to the present invention prior to coating.

### DETAILED DESCRIPTION OF THE INVENTION

The present invention provides a cutting tool for machining by chip removal comprising a body of a polycrystalline cubic boron nitride (PcBN) based material, onto which a wear resistant coating is deposited. The coating is composed of one or more layers of refractory compounds comprising at least one layer consisting of crystals of (Me,Si)X phase, preferably grown using physical vapour deposition (PVD). Additional layers are composed of nitrides and/or carbides and/or oxides from group 4-6 of periodic table. Tools according to the present invention are particularly useful in metal cutting applications of finishing hardened steels or grey cast iron where the surface roughness of the machined part often limits the tool life.

The (Me,Si)X layer(s) comprise(s) crystals of Me₁₋ₐSiₐX_{b} phase, where Me is one or more of the elements Ti, Zr, Hf, V, Nb, Ta, Cr, and Al, preferably Ti, Cr, Zr and Al and a is between 0.05 and 0.4, preferably between 0.1 and 0.3, and X one or more of the elements N, C, O and B and b is between 0.5 and 1.1, preferably between 0.8 and 1.05.

The existence of a crystalline Me₁₋ₐSiₐX_{b} phase is detected by X-ray diffraction (XRD) using CuKα radiation in θ-2θ and/or gracing incidence geometry showing one or more of the following features:
an (Me,Si)X (111) peak, for Ti₁₋ₓSiₓN at about 36 °2θ,
an (Me,Si)X (200) peak, for Ti₁₋ₓSiₓN at about 42 °2θ,
an (Me,Si)X (220) peak, for Ti₁₋ₓSiₓN at about 61 °2θ
When Me is not Ti, or the relative amounts of Me and Si are different, the peak positions could be shifted.
The structure of the (Me,Si)X is preferably of NaCl type.
The texture defined as the ratio, K, between the area of the Me₁₋ₐSiₐX_{b} (111) peak (A(Me₁₋ₐSiₐX_{b})₁₁₁) and the area of the Me₁₋ₐSiₐX_{b} (200) peak (A(Me₁₋ₐSiₐX_{b})₂₀₀), i.e. K=A(Me₁₋ₐSiₐX_{b})₁₁₁/A(Me₁₋ₐSiₐX_{b})₂₀₀, in the X-ray diffraction pattern, in θ-2θ geometry is between 0.0 and 1.0, preferably between 0.0 and 0.3, and/or that the peak-to-background ratio (counts at peak maximum divided by average background counts close to the peak) for the Me₁₋ₐSiₐX_{b} (200) peak is larger than 2, preferably larger than 4.
The peak broadening FWHM (Full Width Half Maximum) value of this layer is mainly an effect of its small grain size. (The contribution from the instrument is in the order of 2θ=0.05° and can thus be disregarded in these calculations.)
   The FWHM of the (Me,Si)X (111) peak is between 0.4 and 1.5 °2θ and/or
   The FWHM of the (Me,Si)X (200) peak is between 0.4 and 1.5 °2θ
X consists of less than 30 at-% O and/or B with balance of N and/or C. Nitrides are preferred to carbonitrides and carbides. X in (Me,Si)X shall be less than 15 at % C. The addition of 1-10 at-% O will promote the growth of a fine-grained structure and improve the oxidation resistance, however, this will increase the risk to get a non-conductive coating chamber and thereby give production problems.
An amorphous phase identified as a broad peak (FWHM=4°-6°) positioned at 2θ=36°-38°. The ratio between the amorphous phase and the crystalline phase, measuring the refracted intensity of the amorphous peak, Aₐ, and the intensity of the crystalline (200)-peak, A_{c}, is typically 0≦Aₐ/A_{c}<0.20.

The layer comprising (Me,Si)X has a considerably increased hardness compared to a cubic single phase layer of a NaCl-type Ti_{1-y}Al_{y}N structure, see Example 1, as demonstrated by the systems Ti₁₋ₓSiₓN and Ti_{1-y}Al_{y}N.

The total coating thickness, if the (Me,Si)X containing layer(s) according to the present invention are combined with other layer(s), is 0.1 to 5 μm, preferably 0.1 to 3 μm, with the thickness of the non (Me,Si)X containing layer(s) varying between 0.1 and 3 μm. For finishing applications the coating thickness is less than 2 μm, preferably less than 1.2 μm.

In one embodiment the (Me,Si)X containing layer(s), 0.1 to 2 μm thickness, are one of up to five different materials in a 0.5 to 5 μm thick multi-layer coating consisting of individually 2-100, preferably 5-50, layers.

In one preferred embodiment Me=Ti with composition (Ti_{0.9-0.7}Si_{0.10-0.30})N most preferably (Ti_{0.85-0.75}Si_{0.15-0.25})N.

In another preferred embodiment Me=Ti and Al with composition (Ti_{0.6-0.35}Al_{0.20-0.40}Si_{0.15-0.30})N most preferably (Ti_{0.6-0.35}Al_{0.25-0.35}Si_{0.15-0.30})N.

In a further preferred embodiment a top layer of TiN and/or CrN and/or ZrN, or mixture thereof is deposited outermost.

The PcBN has a cubic boron nitride (cBN) content between 30 and 80 vol-% for machining of hardened steels and 80 and 90 vol-% for machining of cast iron, preferably between 35 and 60 vol-% cBN with a grain size of 0.5-2 μm in a Ti(C,N) NaCl-type binder phase for machining of hardened steels.

Preferably the composition of the layer according to the present invention is such that its unit cell parameter is within +/−2% and most preferably within +/−1% of that of the NaCl-phase structured binder phase in order to obtain an increased amount of epitaxial growth and a maximum in adhesion strength. The unit cell parameter of the NaCl-structured binder phase is measured using X-ray diffraction on a polished cross section of the sample. The unit cell parameter of the layer is measured using x-ray diffraction on the coated sample. This layer is preferably in direct contact with the substrate. Examples of such unit cell matched compositions are (Ti_{0.85-0.75}Si_{0.15-0.25})N and (Ti_{0.37}Al_{0.25}Zr_{0.18}Si_{0.20})N. Alternatively there may be a <0.3 μm intermediate layer(s), not unit cell matched, therebetween.

The present invention also relates to a method of growing layers comprising (Me,Si)X phase on a PcBN substrate.

First, an optimised surface condition is obtained preferably by applying a soft Ar ion etching which enables good etching and cleaning of the cBN grains as well as the binder phase without decreasing the surface content of binder phase by preferential sputtering. The surface content of binder phase shall be equal to or higher than that of the bulk. The Ar ion etching is performed in an Ar atmosphere or in a mixture of Ar and H₂, whereby in the latter case a combined effect of physical sputtering and chemical etching is achieved, in a sequence of two and more steps where the average energy of impinging ions are successively decreased starting at a substrate bias, Vₛ<−500V to end with Vₛ>−150V. The intermediate step(s), if any, use −500V<Vₛ<−150V. Most preferably the applied substrate bias is pulsed with a frequency >5 kHz with a bipolar voltage applied. The negative pulse is preferably >80% followed by a positive decharging pulse.

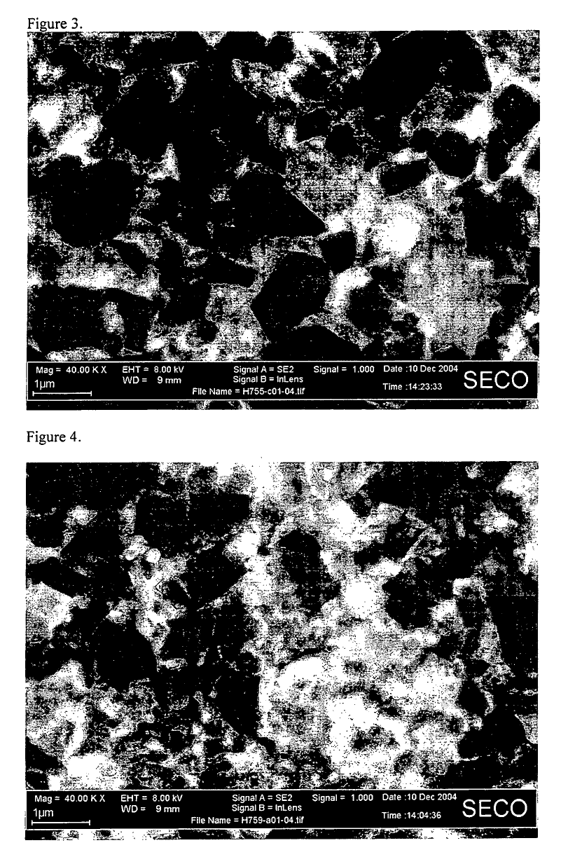

FIG. 3 is a SEM micrograph showing the structure of a PcBN material with a NaCl-type structured binder phase after conventional ion etching prior to coating and FIG. 4 after ion etching according to the present invention prior to coating. As can be seen when comparing FIGS. 3 and 4, the conventional ion etching removes too much of the binder phase thus exposing the cBN grains. The ratio L, defined as the fractional projected surface area of cBN, A_{cBN}, divided by the fractional volume of cBN, V_{cBN}, (L=A_{cBN}/V_{cBN}), prior to deposition, is <1.15 preferably <1.0. The surface content of cBN in FIG. 3 is 59% (L=1.18), and in FIG. 4 49% (L=0.98), to be compared with the volume fraction of the bulk of 50%.

The optimum surface can also be obtained by chemical treatment and/or mechanical treatment such as a light blasting prior to deposition and/or in combination with an in-situ process in the deposition system.

In order to obtain the preferred structure of the layer according to the present invention several deposition parameters have to be fine-tuned. Factors influencing the deposition are the temperature in correlation to the energy of the impinging ions, which can be varied by the substrate bias, the cathode-substrate distance and the N₂ partial pressure, P_{N2}.

The method used to grow the layers comprising (Me,Si)X phase of the present invention, here exemplified by the system Ti₁₋ₓSiₓN, is based on arc evaporation of an alloyed, or composite cathode, under the following conditions:

The Ti+Si cathode composition is 60 to 90 at-% Ti, preferably 70 to 90 at-% Ti and balance Si.

The evaporation current is between 50 A and 200 A depending on cathode size and cathode material. When using cathodes of 63 mm in diameter the evaporation current is preferably between 60 A and 120 A.

The substrate bias is between −10 V and −150 V, preferably between −40 V and −70 V.

The deposition temperature is between 400° C. and 700° C., preferably between 500° C. and 700° C.

When growing layer(s) containing (Me,Si)X where X is N an Ar+N₂ atmosphere consisting of 0-50 vol-% Ar, preferably 0-20 vol-%, at a total pressure of 0.5 Pa to 9.0 Pa, preferably 1.5 Pa to 5.0 Pa, is used.

For the growth of (Me,Si)X where X includes C and O, C and/or O containing gases have to be added to the N₂ and/or Ar+N₂ atmosphere (e.g. C₂H₂, CH₄, CO, CO₂, O₂). If X also includes B it could be added either by alloying the target with B or by adding a B containing gas to the atmosphere.

The exact process parameters are dependent on the design and the condition of the coating equipment used. It is within the purview of the skilled artisan to determine whether the requisite structure has been obtained and to modify the deposition conditions in accordance to the present specification.

When growing layer(s) containing (Me,Si)X phase there is a risk that the compressive residual stress becomes very high which will influence the performance negatively in machining applications when sharp cutting edges are used and/or when the demand on good adhesion is of utmost importance. Residual stresses can be reduced by annealing in an atmosphere of Ar and/or N₂ at temperatures between 600° C. and 1100° C. for a period of 20 to 600 min.

Additionally, enhancement is obtained by adding a post-treatment, which improves the surface roughness of the cutting edge. This could be done by wet-blasting. Also, nylon brushes with embedded abrasive grains can be used. Another way is to move the coated PcBN tool through an abrasive medium such as tumbling or dragfinishing.

The present invention has been described with reference to layer(s) containing (Me,Si)X phase deposited using arc evaporation. It is obvious that (Me,Si)X phase containing layer(s) also could be produced using other PVD technologies such as magnetron sputtering.

### Example 1

Polycrystalline cubic boron nitride (PcBN) inserts of type RCGN0803MOS with cBN volume fraction of 50% with an average grain size of 1 μm and a binder phase consisting of Ti(C,N) were cleaned in ultrasonic baths using alkali solution and alcohol and subsequently placed in the PVD-system using a fixture of three-fold rotation. The shortest cathode-to-substrate distance was 160 mm. The system was evacuated to a pressure of less than 2.0×10⁻³ Pa, after which the inserts were sputter cleaned with Ar ions. A bi-polar pulsed process was used where the substrate bias changed between −Vₛ (80%) and +50V (20%) for one period with a frequency of 20 kHz. Vₛ was in the beginning of the process −550 V and subsequently stepped down to −120 V in the end. FIG. 4 shows the appearance of the PcBN surface after etching using this process.

Variant A was grown using arc evaporation of Ti_{0.75}Si_{0.25} cathodes, 63 mm in diameter and variant B using Ti_{0.80}Si_{0.20} cathode. The deposition was carried out in a 99.995% pure N₂ atmosphere at a total pressure of 4.0 Pa, using a substrate bias of −110 V for 60 minutes. The deposition temperature was about 530° C. Immediately after deposition the chamber was vented with dry N₂. As reference a state of the art coating, Ti_{0.34}Al_{0.66}N, was used and an uncoated variant.

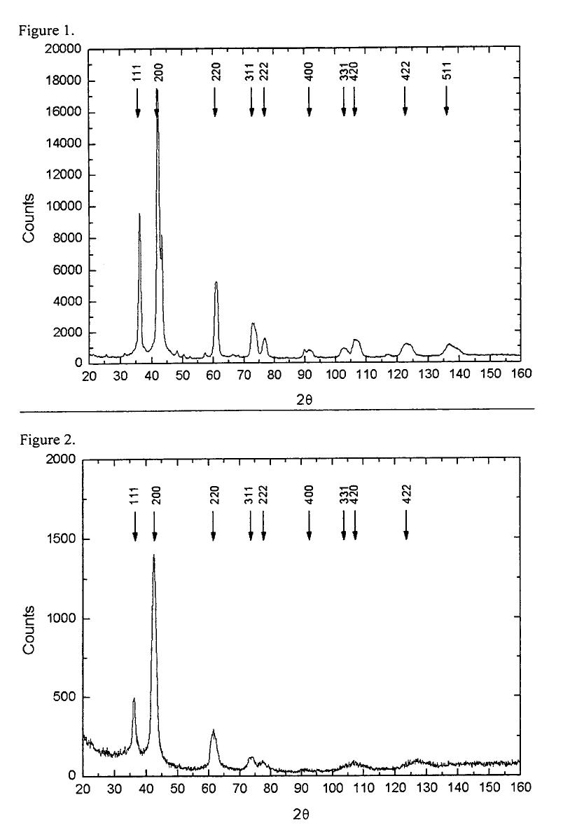

The X-ray diffraction patterns of the as-deposited Ti₁₋ₓSiₓN layer plus a TiN layer are shown in FIG. 1 and FIG. 2. Apart from the peaks corresponding to the PcBN substrates, the only peaks appearing are those corresponding to a cubic NaCl type Ti₁₋ₓSiₓN phase and a cubic NaCl type TiN phase as seen by the identification of the (111), (200), (220), (311), (222), (400), (331), (420), (422), and (511) peaks. The texture, defined as the ratio (K) between the area of the (Me,Si)X (111) peak and the (Me,Si)X (200) peak, is for this variant 0.28. The FWHM of the (Me,Si)X (111) peak is 1.30 °2θ and of the (Me,Si)X (200) peak 1.44 °2θ.

Phase identification of the Ti₁₋ₓSiₓ/N in as-deposited condition was made by X-ray diffraction using a constant gracing incident angle of 1° between primary beam and sample surface and scanning the detector in order to magnify peaks originating from the coating, see FIG. 2. The presence of Ti₁₋ₓSiₓN is confirmed by the indexing of the diffraction pattern in the NaCl type structure.

The peak-to-background ratio for the Ti₁₋ₓSiₓN (200) peak was 24.

The thickness at the cutting edge was 1.0 μm of the Ti₁₋ₓSiₓN layer using scanning electron microscope (SEM) on a cross-section.

The unit cell parameter of (Ti_{0.77}Si_{0.23})N was 4.29 Å, of the PcBN binder phase consisting of Ti(C,N) phase 4.30 Å and 4.14 Å of Ti_{0.34} Al_{0.66}N.

The Vickers hardness of the layers was measured by nanoindentation using a Nano Indenter™ II instrument on polished tapered cross-sections using maximum load of 25 mN resulting in a maximum penetration depth of about 200 nm. The hardness is reported in Table 1. It can be seen from Table 1 that the hardness increases drastically when Si is present in the layer compared to a Ti_{1-y}Al_{y}N variant.

TABLE 1

| | | | FWHM | FWHM | Texture |
|---|---|---|---|---|---|
| | Hardness | Phases | (111) | (200) | parameter |
| Variant | (GPa) | detected | °2θ | °2θ | K |
| A | 48 | Ti_{0.77}Si_{0.23}N, | 1.30 | 1.44 | 0.28 |
| | | TiN | | | |
| B | 45 | Ti_{0.82}Si_{0.18}N, | 1.18 | 1.20 | 0.34 |
| | | TiN | | | |
| C | 32 | Ti_{0.34}Al_{0.66}N, | — | — | — |
| | | TiN | | | |
| D | — | Uncoated | — | — | — |

### Example 2

The coated cutting tool inserts from Example 1 consisting of polycrystalline cubic boron nitride (PcBN) inserts of type RCGN0803MOS were tested in a finishing operation on case hardened gear wheels. The cutting data used was as follows:
Material: SAE 5120 (20MnCr5), 59-61 HRC
v_{f}=190 m/min
aₚ=0.10 mm
fₙ=0.07 mm/rev.

The tool life criterion was number of gear wheels machined giving a minimum buoyancy level of 75% for the machined parts. The results are found in Table 2.

TABLE 2

| | Number of machined |
|---|---|
| Variant | parts |
| A | 525 |
| B | 500 |
| C | 200 |
| D | 80 |

This test shows that variants A and B (this invention) can machine the highest number of parts followed by variant C.

### Example 3

Cutting tool inserts of wiper style coated similarly as in Example 1 consisting of polycrystalline cubic boron nitride (PcBN) inserts of type CNGA120408S-L1-WZ in a finishing operation of a case hardened gearshaft. The cutting data used was as follows:
Material: SAE 5115 (16MnCrS5), 58 HRC
v_{f}=190 m/min
aₚ=0.15/0.35 mm
fₙ=0.3 mm/rev.

The tool life criterion was number of gearshafts machined giving a maximum surface roughness. The results are found in Table 3.

TABLE 3

| | Number of machined |
|---|---|
| Variant | parts |
| A | 236 |
| C | 170 |

This test shows that variants A (this invention) can machine the highest number of parts.

### Example 4

Cutting tool inserts coated similarly as in Example 1 consisting of polycrystalline cubic boron nitride (PcBN) inserts of type CNGA120408S-L0-B in on through hardened socket. The cutting data used was as follows:
Material: SAE 52100 (100Cr6), 63 HRC
v_{f}=220 m/min
aₚ=0.11/0.15 mm
fₙ=0.3 mm/rev.

The tool life criterion was number of sockets machined giving a maximum surface roughness. The results are found in Table 4.

TABLE 4

| | Number of machined |
|---|---|
| Variant | parts |
| B | 175 |
| C | 124 |

This test shows that variants B (this invention) can machine the highest number of parts.

1. Cutting tool insert, solid end mill, or drill produced by the method of claim 16, comprising a substrate of polycrystalline cubic boron nitride (PcBN) based material and a coating formed of one or more layers of refractory compounds of which at least one layer comprises a (Me,Si)X phase described with the composition Me₁₋ₐSiₐX_{b} where Me is one or several of the elements Ti, Zr, Hf, V, Nb, Ta, Cr and Al, a is between 0.05 and 0.4, and X one or more of the elements N, C, O and B and b is between 0.5 and 1.1, and X contains less than 30 at-% of 0+B.

2. Cutting tool insert according to claim 1, wherein the structure of the Me₁₋ₐSiₐX_{b} is of NaCl type.

3. Cutting tool according to claim 1, wherein said coating includes at least one layer of a crystalline cubic phase, (Me,Si)X, as detected by X-ray diffraction in θ-2θ and/or gracing incidence geometry showing one or more of the following features:
a (Me,Si)X (111) peak,
a (Me,Si)X (200) peak,
a (Me,Si)X (220) peak.

4. Cutting tool according to claim 3, wherein the ratio K, between the area of the Me₁₋ₐSiₐX_{b} (111) peak (A(Me₁₋ₐSiₐX_{b})₁₁₁) and the area of the Me₁₋ₐSiₐX_{b} (200) peak (A(Me₁₋ₐSiₐX_{b})₂₀₀), i.e. K=A(Me₁₋ₐSiₐX_{b})₁₁₁/A(Me₁₋ₐSiₐX_{b})₂₀₀, in the X-ray diffraction pattern, in θ-2θ geometry, from said layer, is between 0.0 and 1.0, and/or that the peak-to-background ratio (counts at maximum peak height divided by average background counts close to the peak) for the Me₁₋ₐSiₐX_{b} (200) peak is larger than 2.

5. Cutting tool insert according to claim 3, wherein the FWHM (Full Width Half Maximum) value of the Me₁₋ₐSiₐX_{b} (111) peak in the X-ray diffraction pattern, in θ-2θ geometry, from said layer is between 0.4 and 1.5 °2θ and Me₁₋ₐSiₐX_{b} (200) peak is between 0.4 and 1.5 °2θ.

6. Cutting tool insert according to claim 4, wherein the FWHM (Full Width Half Maximum) value of the Me₁₋ₐSiₐX_{b} (111) peak in the X-ray diffraction pattern, in θ-2θ geometry, from said layer is between 0.4 and 1.5 °2θ and Me₁₋ₐSiₐX_{b} (200) peak is between 0.4 and 1.5 °2θ.

7. Cutting tool insert according to claim 1, wherein the PcBN has cubic boron nitride (cBN) content between 30 and 90 vol-% for machining of hardened steels and 80 and 90 vol-% for machining of cast iron, with a grain size of 0.5-2 μm in a Ti(C,N) NaCl-type binder phase for machining of hardened steels.

8. Cutting tool insert according to claim 6, wherein the unit cell parameter of the layer is within +−2%, of the unit cell parameter of the NaCl-type structured binder phase if present, said layer being in direct contact with the substrate or with a <0.3 μm intermediate layer(s) therebetween.

9. Cutting tool insert according to claim 7, wherein X=N with composition (Me_{0.9-0.7}Si_{0.10-0.30})N.

10. Cutting tool insert according to claim 8, wherein Me=Ti with composition (Ti_{0.85-0.75}Si_{0.15-0.25})N.

11. Cutting tool insert according to claim 7, wherein Me=Ti and Al with composition (Ti_{0.6-0.35}Al_{0.20-0.40}Si_{0.15-0.30})N.

12. Cutting tool insert according to claim 1, wherein a is between 0.1 and 0.3.

13. Cutting tool insert according to claim 1, wherein b is between 0.8 and 1.05.

14. Cutting tool insert according to claim 4, wherein the ratio K is between 0 and 0.3.

15. Cutting tool insert according to claim 7, wherein Me=Ti and Al with composition (Ti_{0.6-0.35}Al_{0.25-0.35}Si_{0.15-0.30})N.

16. A method for producing a coated cutting tool insert, solid end mill, or drill, comprising the steps of: a) forming a substrate of polycrystalline cubic boron nitride (PcBN) based material, said substrate having a surface;
b) pre-treating said substrate surface by Ar ion etching performed in a sequence of at least two steps starting at a substrate bias, Vₛ<−500V and ending with Vₛ>−150 to thereby obtain a surface having a lower fractional projected surface area of the cBN phase compared to the fractional volume of the cBN the ratio L, defined as the fractional projected surface area of cBN, A_{cBN}, divided by the fractional volume of cBN, V_{cBN}, (L=A_{cBN}/V_{cBN}), prior to deposition, being <1.15, preferably <1.0; and
c) applying a coating to said pre-treated substrate surface by deposition using arc evaporation at an evaporation current of 50-200 A, a substrate bias of −10 to −150 V, a temperature of 400-700° C., a total pressure of 0.5-9 Pa, said coating comprising at least one layer including a Me₁₋ₐSiₐX_{b} phase refractory compound wherein Me is selected from the group consisting of Ti, V, Cr, Zr, Nb, Mo, Hf, Ta, Al, and combinations thereof, a is between 0.05 and 0.4, X is selected from the group consisting of N, C, O, B and combinations thereof, b is between 0.5 and 1.1, and wherein X contains less than about 30 at-% of O+B.
